(19) United States
(12) Patent Application Publication
(10) Pub. No.: US 2006/0083379 A1
(43) Pub. Date: Apr. 20, 2006

(54) Cryptographic communications session security

(76) Inventor: George M. Brookner, Norwalk, CT (US)

Correspondence Address: PERMAN & GREEN, 425 POST ROAD, FAIRFIELD, CT, 06824, US

(21) Appl. No.: 11/047,261

(22) Filed: Jan. 31, 2005

Related U.S. Application Data
(60) Provisional application No. 60/620,122, filed on Oct. 19, 2004.

(51) Int. Cl. H04L 9/00

(52) U.S. Cl. 380/286

(57) ABSTRACT

A method of cryptographically securing communications includes converting the communications to quantum states, observing the quantum states, and confirming that the observed states equate to the converted quantum states.

This application claims the benefit of U.S. Provisional Application No. 60/620,122 filed Oct. 19, 2004, which is incorporated by reference herein in its entirety.

### BACKGROUND

The disclosed exemplary embodiments relate to a method of cryptographically securing communications.

### BRIEF DESCRIPTION OF RELATED DEVELOPMENTS

Cryptography has as its purpose the exchange of information such that the right to use the information is autonomously constrained to a single intended recipient. Historically, the security of an encrypted text relied upon the concealment of the intact encrypting and decrypting procedures.

Public key cryptography systems are one type of well known mechanisms for securely protecting digital information. Typically, public key certificates are used by parties or devices exchanging messages. Other data structures, such as attribute certificates, may be used to specify information other than public keys so that the information may be conveyed in a trusted manner. Attributes certificates, as known in the art, may be associated with a specific public key by binding the attribute information (specific information), to the public key by the serial number of a corresponding public key certificate, or to a hash-value of the public key or certificate, or in any other suitable manner.

These types of systems allow the algorithm for encrypting and decrypting to be exposed without comprising the security of a particular secret code. In such a secret code a key is supplied together with the plaintext as an input to the encrypting algorithm, and together with the secret code results in the input to the decrypting algorithm. The encrypting and decrypting algorithms are within the public domain and are not secret. The security of the secret code depends entirely on the secrecy of the key which is made up from a random string of bits.

With the creation of the secret key, subsequent communication entails sending secret code over a public network which is vulnerable to passive spying. Consequently, as a precursor to the creation of the key, the communicating parties must use a very secure channel to share the common key. The capturing of such key exchange may be accomplished by measurements performed by an eavesdropper on this communicating interchanges. In principle, any standard key distribution can always be passively scrutinized without the genuine users being aware that any fraudulent monitoring has taken place. It is provably impossible to establish a secret key with conventional communications, and so key distribution has relied on the establishment of a physically secure channel (“trusted couriers”) or the conditional security of “difficult” mathematical problems in public key cryptography.

It would be advantageous to provide an improved fraud-proof means of data transfer between devices.

### SUMMARY OF THE EXEMPLARY EMBODIMENTS

A method of cryptographically securing communications includes converting the communications to quantum states, observing the quantum states, and confirming that the observed states equate to the converted quantum states.

### BRIEF DESCRIPTION OF THE DRAWINGS

The foregoing aspects and other features of the present invention are explained in the following description, taken in connection with the accompanying drawings, wherein:

FIG. 1 shows a block diagram of a system suitable for practicing the invention; and

FIG. 2 shows a remote device for operation within the system of FIG. 1.

### DETAILED DESCRIPTION OF THE PREFERRED EMBODIMENTS

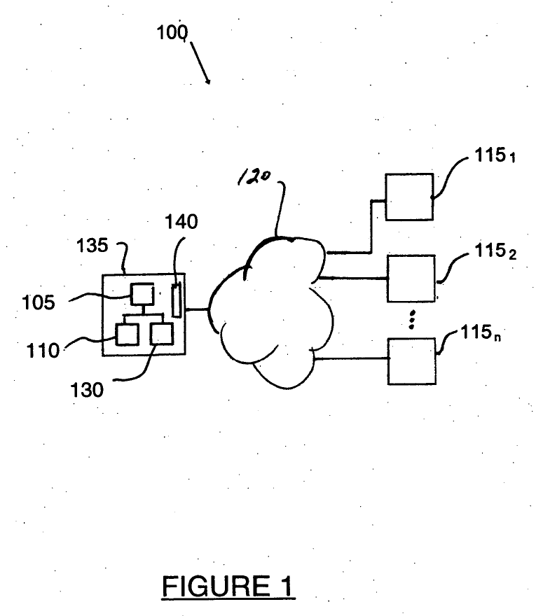

FIG. 1 shows a block diagram of a system suitable for practicing the invention disclosed herein. Although the present invention will be described with reference to the embodiment shown in the drawings, it should be understood that the present invention can be embodied in many alternate forms of embodiments. In addition, any suitable size, shape or type of elements or materials could be used.

System 100 is a system for providing services, for example, a postal services provider system. System 100 includes one or more remote devices, for example, indicia producing or marking devices, shown in FIG. 1 as meters 115₁ . . . 115ₙ, and a remote data center, shown generally as a server 135.

It is a feature of the present invention for the data center and the remote devices to exchange cryptographically secure data.

The present invention provides a significant and drastic improvement to public key cryptographic mechanisms in setting up and guaranteeing a fraud-proof means of data transfer between a postage device and its associated remote data center is introduced. The invention will utilize quantum cryptography as the means to establish a secure communications session, subsequent to which the privacy and/or security of the ensuing messaging is guaranteed.

It is a feature of the present invention to provide provably secure key distribution through quantum communications.

The disclosed embodiments address the provide a system and method of key distribution between the postage device and its remote data center that is accomplished by quantum cryptography, and avoids the transmission of an encrypted message itself. The term quantum key distribution (QKD) will be applied herein. The primary security feature of QKD is that it is impossible to “(wire)tap or bug” single quantum signals. QKD resists interception and retransmission by an eavesdropper because in quantum mechanics, in contrast to the classical world, the result of a measurement cannot be thought of as having a “possessed value” of a quantum state. With reference to Heisenberg's uncertainty principle, said principle ensures that the eavesdropper's activities must produce an irreversible change in the quantum states (“collapse of the wave function”) before they are retransmitted to the intended recipient. These changes will introduce an anomalously high error rate in the transmissions between the sender and intended recipient, allowing them to detect the attempted eavesdropping. Thus, the two important security features of QKD are that eavesdroppers cannot reliably acquire key material, and any attempt to do so will be detectable.

The disclosed embodiments are directed to eliminating the possibility of any third party not part of the desired communication exchange to impersonate either entity or to attempt to compromise the secret code being communicated between the two originating responsible entities. The use of cryptography for a sender and an intended recipient is to enable those entities to communicate in a form that is unintelligible to third parties, and for the authentication of messages to prove that they were not altered in the transceiving process. This is accomplished when the sender and recipient are in possession of shared, secret “key” material. The disclosed embodiments attempt to obviate the principal problem of cryptography, that being the “key distribution problem.” In other words, the disclosed embodiments allow the sender and intended recipient to exchange secret key material while ensuring that third parties (“eavesdroppers”) cannot acquire the information.

The disclosed embodiments provide secure key distribution utilizing quantum communications. Thus, the aforementioned remote device 115 and the remote data center 135 may exchange cryptographically secure data without the fear of a third party successfully eavesdropping on the transmissions.

In one embodiment, data center 135 may communicate with remote devices 115₁ . . . 115ₙ by exchanging photons, or by measuring or observing photons emitted by the data center or the remote device. Other types of communication are also contemplated.

Data center 135 generally includes a processor 105, a memory 110, and a database 130 for storing information. Processor 105 generally operates under the control of programs stored in memory 110 to manage operations of data center 135. Data center 135 generally provides updates, programs that allow additional functionality, replacement programs, data tables and other data and information to remote devices 115₁ . . . 115ₙ. In addition, data center 135 may collect data from remote devices 115₁ . . . 115ₙ, provide reporting and accounting services, and exchange cryptographically secure data with the remote devices.

Data center 135 may be coupled to a data communications network 120. Data communications network 120 may include any suitable communications network, for example, the Public Switched Telephone Network (PSTN), a wireless network, a wired network, a Local Area Network (LAN), a Wide Area Network (WAN), virtual private network (VPN) etc. Data center 135 may communicate with remote devices 115₁ . . . 115ₙ using any suitable protocol, or modulation standard, for example, X.25, ATM, TCP/IP, V34, V90, etc. When data communications network 120 is implemented as a wireless network, it generally incorporates an air interface utilizing any suitable wireless communication protocol or signaling techniques or standards, for example TDMA, CDMA, IEEE 802.11, Bluetooth, close range RF, optical, any appropriate satellite communication standards, etc.

Data center 135 also has an interface 140 that provides photon based communications as described herein.

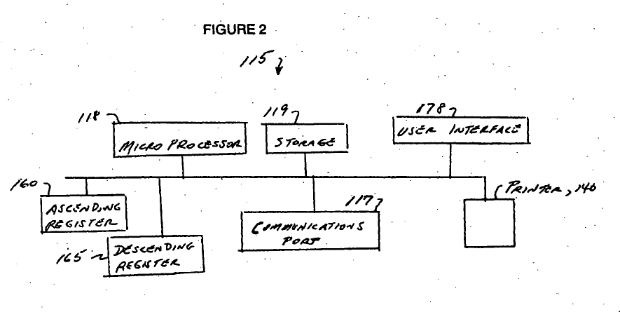

FIG. 2 shows a general block diagram of a remote device 115. Remote devices 115₁ . . . 115ₙ generally provide services to one or more customers. In one embodiment, the remote devices may provide indicia that has value, for example, postage, tickets allowing admission to an event or allowing the use of a service, etc. Remote device 115 may include a communications port 117 that provides photon based communications as described herein. Remote device may also include a microprocessor 118 for performing accounting, control, and handling functions according to programs stored in a storage device 119. Some of these functions or subsets of these functions may be grouped within a secure perimeter as what is commonly referred to as a (PHOTON) Postal Security Device (PSD).

Storage device 119 generally stores machine readable program code which is adapted to cause microprocessor 118 to perform functions associated with providing services, for example, producing indicia. Storage device may also include programs for managing cryptographically secure communications between remote device 115 and data center 135. Storage device 119 may utilize optical, magnetic, semiconductor, electronic, or other types of suitable devices to store the program code.

To eliminate others from responding successfully by subverting the digitally signed and/or encrypted key exchange between a postage device and its remote data center, quantum cryptography will be implemented to establish the secret key to be used between the remote device and data center to assure a secure communications session. Once the secret key is established between the remote device and data center, said secret key will henceforth be used as the key with which to encrypt communications between the two communicating entities. This invention provides a cryptographic system for the distribution of a secret random cryptographic key between the postage device and remote data center that shares no secret information of use to an eavesdropper having unlimited computing power.

Once the secret key is established, it will be used along with existing cryptographic methodologies such as RSA, DSA, or Elliptic Curve, to allow the remote device and data center to communicate in unconditional security. The use of said methodologies will provide for the authenticity of the data exchanges between the remote device and the data center [NOTE: the use of the term ‘data center’ can also mean “infrastructure’, ‘host’, ‘server’] via the digital signatory procedures provided by said cryptographic methodologies. The secret key used for encrypting the messages during the communications session may be applied to the real-time Vernam encryption scheme (referred to as “one-time pad”). The quantum key is formed during the photon transmission, and the Vernam cipher is unvulnerable to any computer attack of any strength. Thus, as applied to establishing a secure communications between the remote device and the data center, quantum cryptography may replace the Diffie-Hellman key exchange algorithm.

After the quantum secret key distribution a normal encryption/decryption technique is used over standard fiber-optic lines or through the atmosphere. The secret key is chosen by a random quantum process rather than picked by a random number generator, thus avoiding the computational probability of cracking a typical encryption algorithm. Different quantum states are used, as photon polarization, to represent ones and zeros in a manner that cannot be observed without the receiver sensing the observation.

The approach herein to quantum transmission of information encompasses the remote device or data center (the entity establishing the communications) encoding information in quantum states, and the opposite entity observing the states and then publicly relating to the sender the states observed. The remote device and data center agree on an information content to share.

Since quantum cryptography does not depend on difficult mathematical problems for its security, it is not threatened by the development of quantum computers. Quantum cryptography accomplishes this by exploiting the properties of microscopic objects such as photons. Photons can be measured to determine their orientation relative to an orientation baseline of polarization. Photons are quantum objects and have a property only after it has been measured, and the type of measurement impacts the property that the object is found to have. This implies that a photon can only be considered to have a particular polarization after it is measured, and that the basis chosen for the measurement will have an impact on the polarization that the photon is found to have.

A photon is sent through an apparatus to measure its orientation relative to a rectilinear coordinate system. This resolves the question related to “how the photon is oriented relative to a rectilinear coordinate system.” The photon is either vertically polarized or horizontally polarized—there are only two possibilities. Suppose the photon is measured as horizontally polarized. Next this same photon is sent through an apparatus to measure its orientation relative to a diagonal coordinate system. Now the the question relates to “how is the photon oriented relative to a diagonal coordinate system.” The photon is either 45° polarized or 135° polarized—there are only two possibilities. The type of measurement has an impact on what property is found. The fact that a horizontally-oriented photon may subsequently be measured to have a 45° polarization occurs because the state of horizontal polarization is actually a superposition of the two diagonal polarization states. All polarization states are actually superpositions of other polarization states. Once the diagonal measurement is made, all information about the previous “property” of horizontal polarization of the photon vanished. As a result it may be very difficult to determine a photon's rectilinear and diagonal polarizations at the same time.

The transmission of information which leads to the establishment of the secret key between the remote device and the data center would follow a process typified by the protocol using the rectilinear and circular polarization bases for photons. Exemplary steps of a protocol follow, using the convention that remote device (PD) is the sender, and the data center (DC) is the receiver, and hacker (H) is the eavesdropper.
1. PD prepares photons randomly with either rectilinear or circular polarizations.
2. PD records the polarization of each photon and then sends it to DC.
3. DC receives each photon and randomly measures its polarization according to the rectilinear or circular basis. DC records the measurement type (basis used) and the resulting polarization measured. (It is important to remember that the polarization sent by PD may not be the same polarization DC finds if DC does not use the same basis as PD.
4. DC publicly tells PD what the measurement types were, but not the results of the measurements.
5. PD publicly tells DC which measurements were of the correct type. A correct measurement is the correct type that DC used for the basis for measurement as PD did for preparation.
6. PD and DC each throw out the data from measurements that were not of the correct type, and convert the remaining data to a string of bits using a convention such as noted in table 1.

Using an online demonstration program (Henle, 2002), the following example data was generated assuming that PD sends 12 photons. The apparatus that measures rectilinear polarization will be noted as ‘+’. Vertical polarization will equate to a binary ‘one’ and horizontal polarization will equate to a binary ‘0’. The apparatus that measures circular polarization will be noted as ‘o’ Left-circular polarization will equate to a binary ‘0’ and a right-circular polarization will equate to a binary ‘1’.

Table 1 synthesizes the development of the final secret key.

TABLE 1
Step
Description
1
2
3
4
5
6
7
8
9
10
11
12
1
Filters used by PD to prepare photons
+
+
∘
+
∘
∘
∘
+
+
+
∘
∘
2
Polarizations of photons sent by PD
V
H
H
H
R
L
R
L
H
L
R
H
3
Measurements made by DC
+
+
+
+
∘
∘
∘
∘
+
∘
∘
+
4
Results of DC measurements
V
H
H
H
R
L
R
L
H
L
R
H
5
DC publicly tells PD which type of measurement was
made on each photon
+
+
+
+
∘
∘
∘
∘
+
∘
∘
+
6
PD publicly DC which measurements were the correct type
yes
yes
no
yes
yes
yes
yes
no
yes
no
yes
no
7
PD and DC each keep the data from only the correct
measurements and convert to binary
1
0
0
1
0
1
0
1

The string of bits now owned by PD and DC is: 1 0 0 1 0 1 0 1. H has no way of knowing the bit string. This string of bits forms the secret key. In practice, the number of photons sent and the resulting length of the string of bits would be much greater.

The quantum crypto system is explained with the following discussion:

The system includes a transmitter and a receiver. The remote device may use the transmitter to send photons in one of four polarizations: 0, 45, 90, or 135 degrees. The data center at the other end uses a receiver to measure the polarization. According to the laws of quantum mechanics, the data center can distinguish between rectilinear polarizations (0 and 90), or it can quickly be reconfigured to discriminate between diagonal polarizations (45 and 135); it can never, however, distinguish both types. The key distribution requires several steps (see table 1). The remote device transmitter sends photons with one of the four polarizations which are chosen at random. For each incoming photon, the data center receiver chooses at random the type of measurement (either the rectilinear type or the diagonal type). The data center receiver records the results of the measurements but keeps them secret. Subsequently, said receiver publicly announces the type of measurement (but not the results) and the remote device tells said receiver which measurements were of the correct type. The two parties (the remote device and the data center) keep all cases in which the receiver measurements were of the correct type. These cases are then translated into bits (1's and 0's) and thereby become the key. An eavesdropper is bound to introduce errors to this transmission because he/she does not know in advance the type of polarization of each photon and quantum mechanics does not allow him/her to acquire sharp values of two non-commuting observables (here rectilinear and diagonal polarizations).

The two legitimate users of the quantum channel test for eavesdropping by revealing a random subset of the key bits and checking (in public) the error rate. Although they cannot prevent eavesdropping, they will never be fooled by an eavesdropper because any effort to “tap” the channel will be detected. Whenever they are not happy with the security of the channel they can try to set up the key distribution again.

The string of bits now owned by PD and DC (see table 1) become the key with which to encrypt communications between the postal device and its remote data center.

It should be understood that the foregoing description is only illustrative of the invention. Various alternatives and modifications can be devised by those skilled in the art without departing from the invention. Accordingly, the present invention is intended to embrace all such alternatives, modifications and variances which fall within the scope of the appended claims.

What is claimed is:

1. A method of cryptographically securing communications comprising:
converting the communications to quantum states;
observing the quantum states; and
confirming that the observed states equate to the converted quantum states.
